(19) United States
(12) Patent Application Publication
(10) Pub. No.: US 2009/0062024 A1
(43) Pub. Date: Mar. 5, 2009

(54) Mirror Mounting

(75) Inventor: Robert DeBoalt, Hudson, MA (US)

Correspondence Address: Anderson Gorecki & Manaras LLP, 33 NAGOG PARK, ACTON, MA, 01720, US

(73) Assignee: GSI Group Corporation

(21) Appl. No.: 11/845,200

(22) Filed: Aug. 27, 2007

(51) Int. Cl. F16D 1/06

(52) U.S. Cl. 464/182

(57) ABSTRACT

A disk segment is used to facilitate mounting a mirror to a limited rotation motor. The disk segment has a flat edge which defines a cutaway portion such that, when the flat edge is aligned with the plane defined by the reflective surface of the mirror, the disk segment does not impede access to the reflective surface for polishing and other operations. The disk segment is attached to the mirror before the mirror is finished, thereby enabling use of attachment techniques that would be damaging to a finished mirror. The disk segment may be secured to the motor shaft by various means, including but not limited to a threaded coupling and clamp ring. The coupling may include a tapered shaft or compression fitting in order to facilitate rotational alignment of the mirror relative to the motor. Alternatively, the disk segment may be secured directly to a threaded motor shaft with the clamp ring. Shims may be inserted between the disk segment and threaded motor shaft to achieve a desired rotational alignment of the mirror with respect to the motor.

### FIELD OF THE INVENTION

This invention is generally related to mounting structures, and more particularly to mounting structures for lightweight, limited rotation mechanical parts.

### BACKGROUND OF THE INVENTION

Limited rotation mechanical parts are used in many products. For example, limited rotation oscillatory motors (galvanometers) are used to rotate mirrors in discreet steps to direct light beams in optical scanners. High frequency limited rotation exerts considerable torque on the rotating parts during acceleration and deceleration. Consequently, the rate of rotation is limited by the first torsional resonance frequency of the rotating assembly, which is at least in-part a function of shape and mass. Shape is often constrained by the function of the part, e.g., the required dimensions of the mirror. However, various techniques are known for reducing mass, and thereby increasing the first torsional resonance frequency. For example, a prior art optical scanner as illustrated in FIG. 1 utilizes Beryllium mirrors (101) with fluted edges having mass-reducing holes drilled therein.

One technically difficult aspect of manufacturing a mirror and coupling assembly is bonding the mirror (101) to a shaft coupling (105) with adequate strength. In order to couple the mirror to a motor, the base of the mirror is first bonded into a transverse slot (101C) in the shaft coupling (105). The shaft coupling is then mounted on the motor shaft. Alternatively, the motor shaft itself includes a transverse slot adapted to receive the mirror.

The transverse slot (101C) is defined by flanges (107A, 107B). Since flange (107B) necessarily protrudes beyond the plane of the reflective surface (101B) of the mirror (101), it is not practical to finalize the polishing of the reflective surface subsequent to mounting the mirror into the transverse slot. For that reason, it is common practice to finish polishing the reflective surface before mounting. This is problematic because any stresses induced by the mounting and bonding process can distort the reflective surface of the mirror. For example, bonding temperatures may be limited to about 160° C. in order to avoid stressing the mirror. While the depth (106) of the mating surface might be increased to enhance bonding, that would undesirably increase the length of the portion of the finished assembly which is cantilevered from the motor. An improved mirror mounting technique would therefore be desirable.

### SUMMARY OF THE INVENTION

In accordance with one embodiment of the invention, apparatus for mounting a mirror to a limited rotation motor comprises: a disk segment having an edge adapted to be aligned with a plane defined by a reflective surface of the mirror, the disk segment having a mating surface against which a prepared base surface of the mirror is secured, the disk segment being adapted to be coupled to the motor.

In accordance with another embodiment of the invention, a method for mounting a mirror to a limited rotation motor comprises: securing a disk segment to the mirror, the disk segment having an edge adapted to be aligned with a plane defined by a reflective surface of the mirror, and a mating surface against which a prepared base surface of the mirror is secured, the disk segment being adapted to be coupled to the motor.

One of the advantages of the invention is that the mirror can be finished after the mirror has been attached to the disk segment. Prior art mounting systems protrude beyond the plane defined by the reflective surface of the mirror. Such protrusion impedes access to the reflective surface. Consequently, prior art systems mount finished mirrors, which are susceptible to heat and stress caused by the mounting technique. Since the disk segment does not protrude beyond the plane define by the reflective surface of the mirror, the mirror may be processed for stress-relief and the reflective surface may be polished subsequent to mounting on the disk segment. This is particularly advantageous because attaching the mirror to the disk segment before the mirror is finished enables use of attachment techniques that require relatively high heat and other conditions that would be damaging to a finished mirror.

Another one of the advantages of the invention is that the length of the overall mirror assembly may be reduced. At least some prior art mounting systems utilize a transverse slot which receives the base of the mirror. The strength of the joint formed in the transverse slot is at least in-part a function of slot depth. However, increasing slot depth tends to increase the length of the overall assembly for a mirror of given length. This is problematic because the assembly is cantilevered from the motor, and increasing the length therefore increases susceptibility to vibration. At least one embodiment of the present invention mitigates this problem by securing the mirror to the disk segment on a planar prepared base surface, i.e., without flanges. Use of such a joint is enable because the mirror is mounted prior to finishing, such as by soldering or brazing, which are relatively strong but would possibly damage a finished mirror.

### BRIEF DESCRIPTION OF THE FIGURES

FIG. 1 illustrates a prior art mirror mounting technique.

FIG. 2 illustrates a mount which permits polishing subsequent to mounting the mirror, and which is coupled to a motor by press-fit.

FIG. 3 illustrates a cross-sectional view of the mount of FIG. 2 taken along 2-2.

FIG. 4 illustrates the threaded attachment of FIG. 2 in greater detail.

FIG. 5 illustrates which permits polishing subsequent to mounting the mirror, and which is coupled to a shaft by compression-fit.

FIG. 6 which permits polishing subsequent to mounting the mirror, and which is coupled to a threaded shaft.

### DETAILED DESCRIPTION

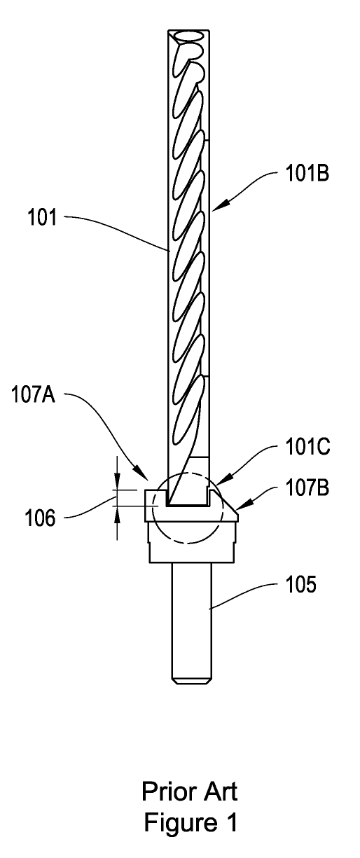

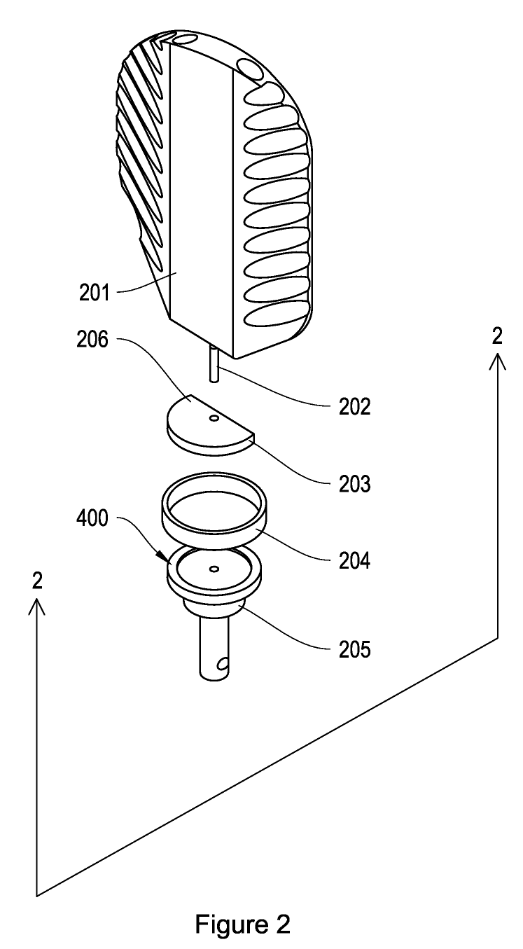

Referring to FIGS. 1 and 2, in one embodiment of the invention a mirror (201) is coupled to a motor by a disk segment (203), alignment pin (202), clamp ring (204), and shaft coupling (205). Initially, a sub-assembly is made which includes the mirror, alignment pin and disk segment (hereafter, “mirror/disk segment sub-assembly (210)”). The mirror (201) is directly coupled to the disk segment (203). In particular, a prepared planar base surface (301A) of the mirror is bonded to a planar surface of the disk segment by soldering or brazing. The alignment pin (202) is utilized to facilitate alignment of the mirror (201) relative to the disk segment (203). In particular, the alignment pin (202) is inserted into a through-hole formed in the disk segment and also into a half-blind hole in the mirror. The half-blind hole and alignment pin may be of particular depth and length, respectively, that the pin bottoms-out in the half-blind hole, leaving a stub of known length protruding from the disk segment. The disk segment (203) defines a portion of a circular surface through greater than 180°, with a flat edge (206). The flat edge is formed to coincide with the plane defined by the reflective surface (301B) of the mirror when the mirror and disk segment are in rotational alignment. When the mirror is aligned with the disk segment by the pin, and the flat edge of the disk segment is aligned with the plane defined by the reflective surface, the mirror is brazed, soldered, or otherwise attached to the disk segment.

After the mirror has been attached to the alignment pin and disk segment, the mirror can be finished. For example, the mirror may be processed for stress-relief, and the reflective surface may be polished. Polishing of the reflective surface (301B) is facilitated by the alignment of the flat edge (206) of the disk segment with the plane defined by the reflective surface of the mirror. In particular, the disk segment (203) does not impede access to the reflective surface by polishing equipment because the disk segment does not protrude beyond the plane defined by the reflective surface. This is particularly advantageous because attaching the mirror to the disk segment before the mirror is finished enables use of attachment techniques that require relatively high heat and other conditions that would be damaging to a finished mirror.

After the mirror has been finished, the mirror/disk segment sub-assembly is mounted on the shaft coupling (205). The shaft coupling includes a half-blind hole positioned to receive the stub of the alignment pin which protrudes from the disk segment. The half-blind hole of the shaft coupling may, but need not necessarily, be formed along the axis of rotation of the shaft coupling. Once the mirror/disk segment sub-assembly is aligned with the shaft coupling by the pin, the sub-assembly is secured to the shaft coupling.

Any of various means known in the art may be utilized to secure the sub-assembly to the shaft coupling. In the illustrated embodiment, a threaded clamp ring is utilized. In particular, the threaded clamp ring is mated to corresponding threads on outer, arcuate surfaces of the disk segment and shaft coupling. It will be appreciated that in order to avoid cross-threading, the threads of the disk segment must be aligned with the threads of the shaft coupling. Consequently, the rotational alignment of the disk segment relative to the shaft coupling is defined by the threads of the disk segment and the shaft coupling.

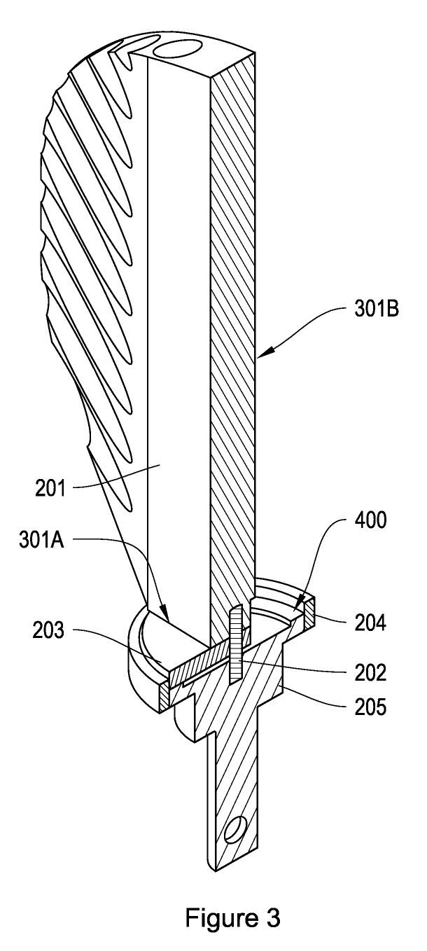

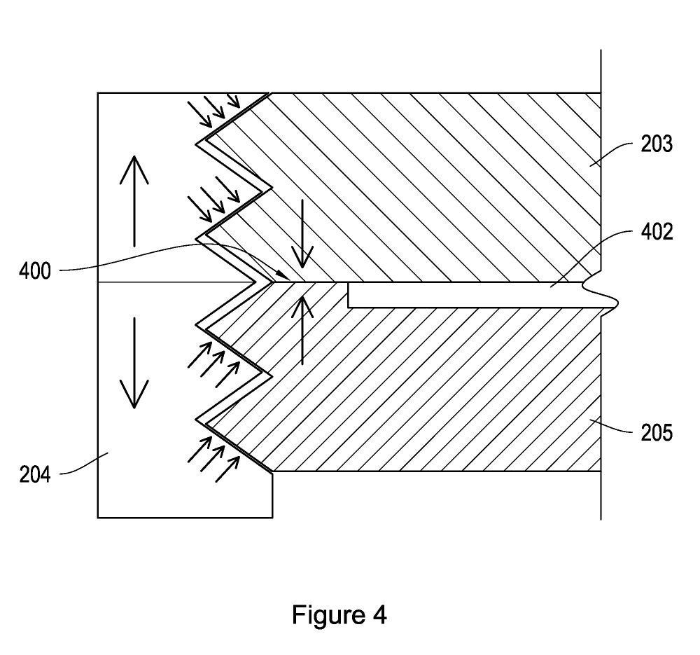

Referring now to FIGS. 2-4, the mated threads will tend to exert force upon the disk segment (203) and shaft coupling (205) in a direction orthogonal to flat mating surfaces defined by the threads. In order to mitigate the possibility of deflection of the disk segment, and associated stresses on the mirror, the disk segment and shaft coupling are mated only along an outer surface which defines an annular ring (400). In the illustrated embodiment this is accomplished by forming a shallow cylindrical hollow (402) in the shaft coupling. However, the hollow could alternatively be formed in the disk segment, or in both the shaft coupling and the disk segment. The annular ring mating surface facilitates isolation of the prepared base surface from stresses induced by securing the disk segment to the shaft coupling.

The shaft coupling (205) is adapted to be mounted to the motor with a rotational position selectable at the time of mounting, i.e., the mirror can be oriented relative to the motor in any of various positions. In the illustrated embodiment, the shaft coupling (205) defines a male taper which corresponds to a female taper defined by the motor shaft, thereby permitting a press-fit in a selected orientation. This feature advantageously permits rotational alignment in situ, which may facilitate mirror replacement in addition to simplifying manufacture.

Various materials may be utilized to form the parts of the mirror mount. Because of the advantages associated with low mass, low density materials may be preferable. Since limited rotation mirrors are commonly manufactured from Beryllium, at least at the present time, the alignment pin, clamp ring, disk segment, and shaft coupling should presently be manufactured from compatible materials, i.e., materials of sufficiently high Young's Modulus which have a coefficient of thermal expansion that is similar to that of the mirror material. Titanium, stainless steel and Beryllium are examples of some materials from which the parts may be manufactured. It should also be noted that although the various parts are illustrated as being separate, some parts could be formed as a single integral part. For example, combinations of two or more of the mirror, alignment pin and disk segment could be cast or machined from a single block of material. Silver-copper and silver-tin-copper alloys are examples of soldering and brazing materials which may be utilized.

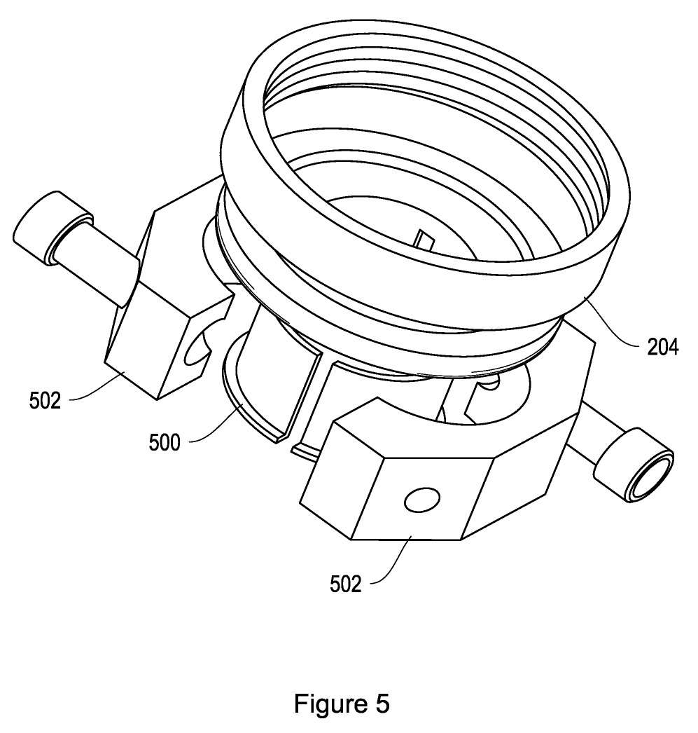

FIG. 5 illustrates an alternative embodiment of the invention. In this embodiment, a compression fitting is utilized to secure the mirror/disk segment sub-assembly to the motor rather than the tapered coupling. The compression fitting is threaded to receive the clamp ring, as described with respect to the shaft coupling. Further, the compression fitting has a shallow cylindrical hollow which produces an annular ring mating surface as described with respect to the shaft coupling. However, unlike the shaft coupling, the compression ring does not define a male taper. Rather, the compression ring includes a segmented cylinder (500) which can be deformed (compressed) between two retaining members (502) by tightening of bolts, thereby reducing the diameter defined by the cylinder. One advantage of this embodiment is that it will mount to a non-tapered motor shaft. Another advantage is that the rotational orientation of the mirror relative to the motor can be selected prior to securing the compression ring to the motor shaft.

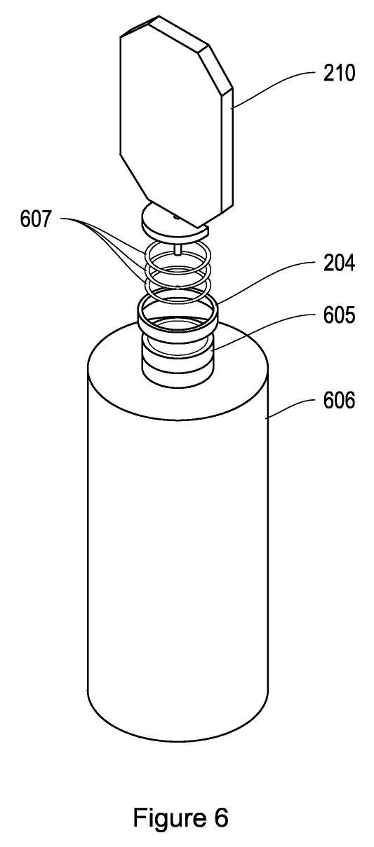

FIG. 6 illustrates another alternative embodiment of the invention. In this embodiment the mirror/disk segment sub-assembly (210) is mounted directly to a threaded motor shaft (605). The sub-assembly may be mounted to the motor shaft by aligning the threads of the sub-assembly with the threads of the motor shaft, and then securing the sub-assembly to the motor shaft with the retaining ring (204). However, it will be noted that such a configuration limits rotational alignment of the mirror relative to the motor (606). Annular ring shims (607) may be utilized to facilitate rotational alignment of the mirror/disk segment sub-assembly (210). The shims define major and minor diameters corresponding to the annular ring (204) mating surface between the motor shaft and the sub-assembly (in this case the shallow cylindrical hollow may be formed in the disk segment). One or more shims are inserted between the mating surfaces of the sub-assembly and the motor shaft in order to alter the distance between the motor shaft and sub-assembly, and thereby change the rotational position at which the threads of the sub-assembly are aligned with the threads of the motor shaft. Since the pitch of the threads is known, the shims may be provided in thicknesses corresponding to degrees of rotational adjustment, depending on required accuracy, e.g., a selection of 1° shims, 5° shim, 10° shims, etc.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative structures, one skilled in the art will recognize that the system may be embodied using a variety of specific structures. Accordingly, the invention should not be viewed as limited except by the scope and spirit of the appended claims.

What is claimed is:

1. Apparatus for mounting a mirror to a limited rotation motor, comprising:
a disk segment having an edge which, when aligned with a plane defined by a reflective surface of the mirror, does not traverse the plane defined by the reflective surface of the mirror, the disk segment having a mating surface against which a prepared base surface of the mirror is secured, the disk segment being adapted to be coupled to the motor.

2. The apparatus of claim 1 further including an alignment pin, and wherein the mirror includes a half-blind hole and the disk segment includes a through-hole, the holes formed to receive the alignment pin and thereby align the disk segment with respect to the mirror.

3. The apparatus of claim 2 further including a coupling member having a hole formed to receive the alignment pin and thereby align the coupling member with respect to the disk segment, the coupling member adapted to be mounted on a shaft of the motor.

4. The apparatus of claim 3 wherein the coupling member and the disk segment are threaded, and further including a threaded clamp ring operable to secure the disk segment to the coupling member.

5. The apparatus of claim 4 wherein a centered cylindrical hollow between the coupling member and disk segment defines an annular ring mating surface.

6. The apparatus of claim 5 wherein the coupling member includes a tapered shaft operable to be press-fitted to the motor shaft.

7. The apparatus of claim 5 wherein the coupling member includes a compression ring operable to be deformed to be secured to a motor shaft of uniform diameter.

8. The apparatus of claim 2 wherein the disk segment is threaded and the limited rotation motor has a threaded shaft, and further including a threaded clamp ring operable to secure the disk segment to the threaded motor shaft.

9. The apparatus of claim 8 wherein a centered cylindrical hollow between the threaded motor shaft and disk segment defines an annular ring mating surface.

10. The apparatus of claim 8 further including at least one annular ring shim of predetermined thickness disposed between the threaded motor shaft and disk segment.

11. A method for mounting a mirror to a limited rotation motor, comprising:
aligning a disk segment having an edge with the mirror such that the edge is aligned with a plane defined by a reflective surface of the mirror, and such that the disk segment does not traverse the plane defined by the reflective surface of the mirror; and
securing the disk segment to the mirror at a mating surface against which a prepared base surface of the mirror is secured, the disk segment being adapted to be coupled to the motor.

12. The method of claim 11 further including the step of employing an alignment pin to align the disk segment relative to the mirror, wherein the mirror includes a half-blind hole and the disk segment includes a through-hole, the holes formed to receive the alignment pin.

13. The method of claim 12 further including the step of securing the disk segment to the motor with a coupling member having a hole formed to receive the alignment pin and thereby align the coupling member with respect to the disk segment, the coupling member adapted to be mounted on a shaft of the motor.

14. The method of claim 13 further including the step of securing the disk segment to the coupling member with a threaded clamp ring, wherein the coupling member and the disk segment are threaded to receive the clamp ring.

15. The method of claim 14 further including the step of forming a centered cylindrical hollow, between the coupling member and disk segment, which defines an annular ring mating surface.

16. The method of claim 15 further including the step of securing the coupling member to the motor shaft with a tapered shaft operable to be press-fitted.

17. The method of claim 15 further including the step of securing the coupling member to the motor shaft with a coupling member that includes a compression ring operable to be deformed to be secured to a motor shaft of uniform diameter.

18. The method of claim 12 wherein the disk segment is threaded and the limited rotation motor has a threaded shaft, and further including the step of securing the disk segment to the threaded motor shaft with a threaded clamp ring.

19. The method of claim 18 including the further step of forming a centered cylindrical hollow between the threaded motor shaft and disk segment which defines an annular ring mating surface.

20. The method of claim 18 further including the step of placing at least one annular ring shim of predetermined thickness between the threaded motor shaft and disk segment.
